(19) United States
(12) Patent Application Publication
(10) Pub. No.: US 2008/0104667 A1
(43) Pub. Date: May 1, 2008

(54) INFORMATION PROCESSING SYSTEM, INFORMATION PROCESSING METHOD, COMPUTER READABLE RECORDING MEDIUM, AND COMPUTER DATA SIGNAL

(75) Inventor: Yoshihiro TERADA, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 11/756,659

(22) Filed: Jun. 1, 2007

(30) Foreign Application Priority Data
Oct. 30, 2006 (JP) 2006-294116

(51) Int. Cl. H04L 9/32

(52) U.S. Cl. 726/2

(57) ABSTRACT

There is provided an information processing system including an authentication information receiving section that receives authentication information used for authentication from a user, an authentication information transmitting section that transmits the received authentication information to a first device, an authentication result receiving section that receives a result of the authentication performed by the first device, a first availability determining section that determines whether a second device is available to the user based on the result of the authentication received by the authentication result receiving section, and a second availability determining section that, when the authentication cannot be performed by the first device, obtains a past authentication result, and determines whether the second device is available based on the obtained past authentication result.

### CROSS-REFERENCE TO RELATED APPLICATIONS

This application is based on and claims priority under 35 U.S.C 119 from Japanese Patent Application No. 2006-294116 filed on Oct. 30, 2006.

### BACKGROUND

1. Technical Field

The present invention relates to an information processing system, an information processing method, a computer readable recording medium, and a computer data signal.

2. Related Art

Multifunction devices have various functions such as those of a printer, a scanner, a facsimile, and a copying machine in a combined manner. Some multifunction devices have a user authentication function for granting permission for use to only predetermined users.

In view of a case where it becomes temporarily impossible to establish a connection to the authentication server, an improvement in device availability is demanded.

### SUMMARY

According to an aspect of the invention, there is provided an information processing system including an authentication information receiving section that receives authentication information used for authentication from a user, an authentication information transmitting section that transmits the received authentication information to a first device, an authentication result receiving section that receives a result of the authentication performed by the first device, a first availability determining section that determines whether a second device is available to the user based on the result of the authentication received by the authentication result receiving section, and a second availability determining section that, when the authentication cannot be performed by the first device, obtains a past authentication result, and determines whether the second device is available based on the obtained past authentication result.

### BRIEF DESCRIPTION OF THE DRAWINGS

An exemplary embodiment of the present invention will be described in detail based on the following figures, wherein:

FIG. 1 is a block diagram showing a configuration and connection example of an information processor according to an exemplary embodiment;

FIG. 2 is a flowchart diagram showing a processing example performed by the information processor according to the exemplary embodiment; and

FIG. 3 is an explanatory diagram showing a content example of authentication recording information recorded by the information processor according to the exemplary embodiment.

### DETAILED DESCRIPTION

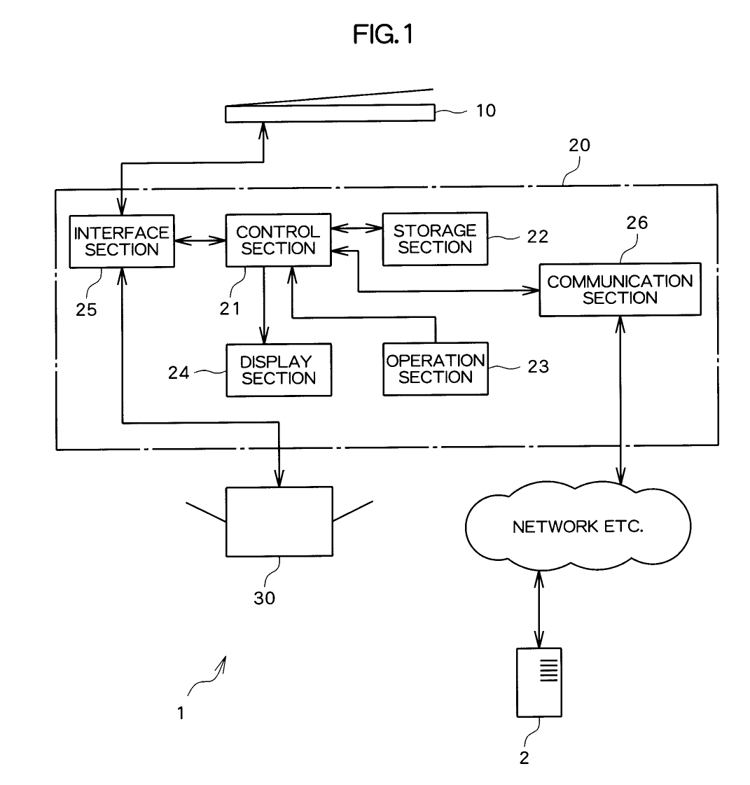

An exemplary embodiment of the present invention will be described based on the figures. As shown in FIG. 1, an information processor 1 serving as a second device according to the exemplary embodiment of the present invention is configured as a multifunction device, for example, and includes a scanner 10, a controller 20, and a printer 30. The controller 20 includes a control section 21, a storage section 22, an operation section 23, a display section 24, an interface section 25, and a communication section 26. The controller 20 is connected to an authentication server 2 serving as a first device via a communication resource such as a network.

The scanner 10 is a flatbed scanner or the like, and optically scans a document placed on a scanning table and outputs the scanned result as image data.

The control section 21 of the controller 20 is a program-controlled device such as a CPU, and operates according to a program stored in the storage section 22. The control section 21 performs processing to authenticate a user. In response to an instruction of an authenticated user, the control section 21 performs processing as a scanner, a copying machine, and the like. An operation of the control section 21 will be described later in detail.

The storage section 22 includes a random access memory (RAM), a read only memory (ROM), and the like. Further, the storage section 22 includes a storage device such as a hard disk drive, which can hold memory contents even when power is not supplied. In this exemplary embodiment, the storage section 22 stores the program executed by the control section 21. The program is provided stored in a recording medium such as a DVD-ROM. The program is copied to and stored in the storage section 22. The storage section 22 also functions as a working memory of the control section 21. In this exemplary embodiment, the above-mentioned hard disk drive holds a result of authentication processing performed by the control section 21, a content of processing performed according to an instruction of the user, and other data.

The operation section 23 is a touch panel or the like, and outputs information and an instruction which are inputted by the user to the control section 21. The display section 24 is a liquid crystal panel or the like disposed at a position where it can be viewed via the touch panel, and displays information according to an instruction received from the control section 21.

The interface section 25 is connected to the scanner 10 and the printer 30, and controls the scanner 10 and the printer 30 according to an instruction received from the control section 21. The interface section 25 outputs image data received from the scanner 10 to the control section 21.

The communication section 26 is a network interface or the like, and is used to exchange information with a communication counterpart connected via the communication resource such as a network. In this exemplary embodiment, the communication section 26 sends information to a specified destination according to an instruction received from the control section 21. The communication section 26 also outputs information received via the communication resource to the control section 21.

The printer 30 is a laser printer, for example, and forms an image on a recording medium such as paper according to an instruction received from the control section 21.

The authentication server 2 is a lightweight directory access protocol (LDAP) server, for example, and holds information used for authentication. The authentication server 2 performs authentication processing in response to an authentication request received from the information processor 1 and returns a result of the authentication to the information processor 1 which is the requester.

In the authentication processing, the authentication server 2 receives information that is an authentication target from the information processor 1, for example, and determines whether the received information is already held in the authentication server 2. The authentication succeeds when the received information is already held in the authentication server 2.

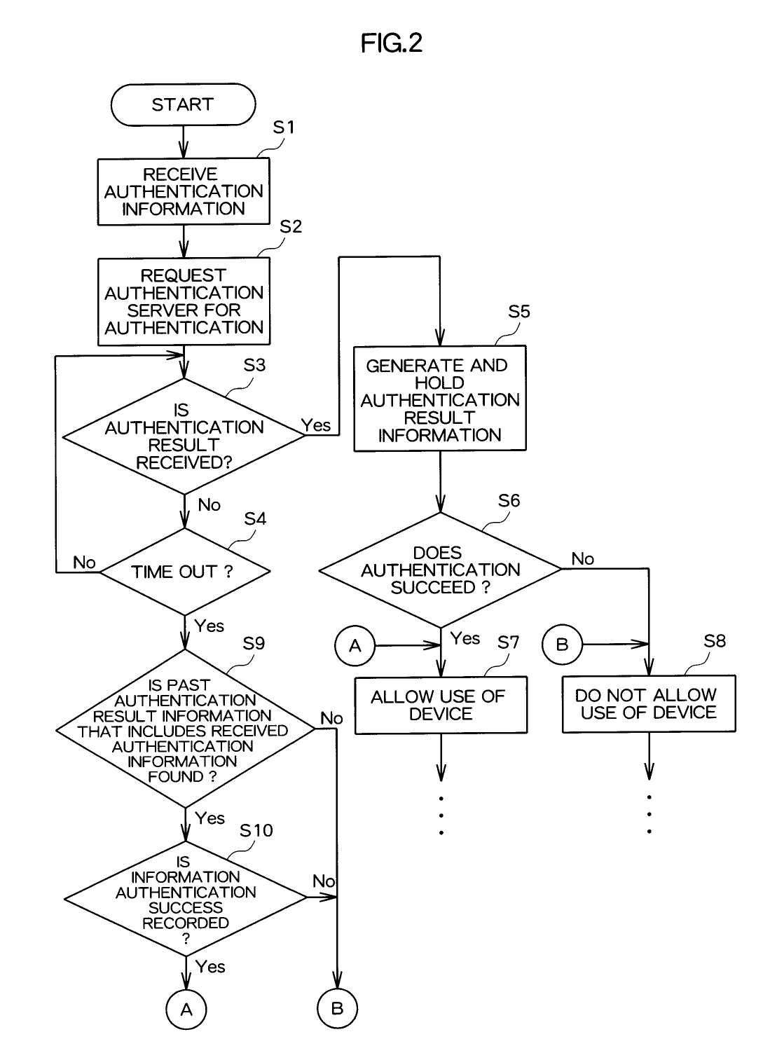

A description is given of an example of the processing performed by the control section 21 of the information processor 1. In this exemplary embodiment, as shown in FIG. 2, the control section 21 first receives authentication information to be used for authentication, from the user (S1). The authentication information may be information of a user name and a password, for example. The authentication information may be inputted through an operation performed using the operation section 23. A portable recording medium (such as an IC card) which records the authentication information may be prepared and distributed to the user in advance. In the case where the authentication information is recorded in the recording medium, the operation section 23 needs to be provided with a card reader/writer C for reading the authentication information from the recording medium.

The control section 21 sends the authentication information received from the user to the authentication server 2 via the communication section 26, to request authentication (S2).

The control section 21 waits to receive an authentication result from the authentication server 2 (S3). The control section 21 measures a predetermined timeout period with a timer (not shown) and determines whether the timeout period has elapsed (S4). If the timeout period has not elapsed, the processing returns to Step S3 and the control section 21 continues the processing.

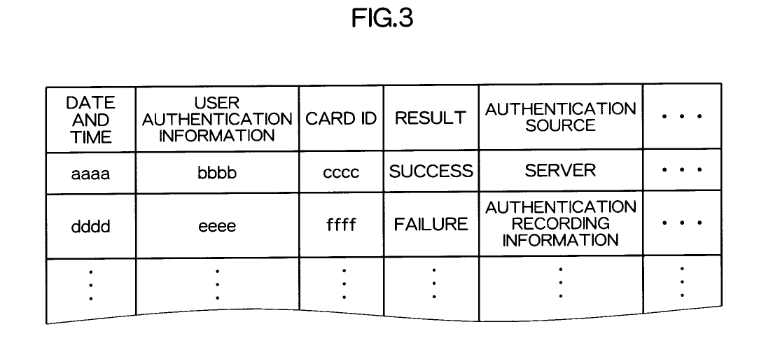

When an authentication result is received from the authentication server 2 in Step S3, the control section 21 generates, accumulates, and records, in the storage section 22, authentication result information, in which the authentication result, the date and time of the authentication (information of date and time is obtained from a timer section (not shown)), the authentication information that has been used for the authentication, and information indicating that the authentication has been performed by the authentication server 2 (referred to as authentication-by-server record) are associated with one another, as shown in FIG. 3 (S5). In the case of reading the authentication information from the recording medium such as an IC card, an identifier (such as a card ID) unique to this recording medium may be further associated with those items of information and recorded.

The control section 21 further refers to the authentication result of the authentication server 2 (S6). Based on the authentication result, the control section 21 determines whether the information processor 1 is available. For example, when the authentication result indicates that the authentication has succeeded, the control section 21 performs processing according to an instruction corresponding to an operation of the information processor 1 issued from the user. In other words, the control section 21 allows the user to use the information processor 1 (S7).

When the authentication result does not indicate in Step S6 that the authentication has succeeded, the control section 21 does not allow the user to use the information processor 1 (S8). In this case, the control section 21 displays information indicating that the authentication has failed on the display section 24 and does not receive an instruction to perform processing as the scanner or the copying machine.

In this exemplary embodiment, if the time-out period has elapsed without receiving an authentication result in Step S4, the control section 21 determines that authentication cannot be performed by the authentication server 2. At this time, the control section 21 determines whether the information processor 1 is available, with reference to a past authentication record stored in the storage section 22. As an example, the control section 21 searches the authentication recording information stored in the storage section 22 for authentication recording information that includes the authentication information received in Step S1 (S9). When authentication recording information that includes the authentication information received in Step S1 is found as a result of the search, the control section 21 determines whether the authentication recording information indicates an authentication success (S10).

When the found authentication recording information indicates an authentication success, the processing proceeds to Step S7, where the control section 21 allows the user to use the information processor 1. When the found authentication recording information does not indicate an authentication success (in other words, it indicates an authentication failure) in Step S10, the processing proceeds to Step S8, where the control section 21 does not allow the user to use the information processor 1.

When authentication recording information that includes the authentication information received in Step S1 is not found in the authentication recording information stored in the storage section 22, in Step S9, the processing may proceed to Step S8, where the control section 21 does not to allow the user to use the information processor 1.

When items of authentication recording information that include the authentication information received in Step S1 are found in the storage section 22 in Step S9, the control section 21 may selectively refer to the latest authentication recording information (authentication recording information whose information of date and time is the latest among the items of authentication recording information).

Further, when the control section 21 selects the latest authentication recording information from among the items of authentication recording information found in Step S9, and the time difference between the date and time of the selected authentication recording information and the current date and time is greater than (or equal to) a predetermined threshold, the processing may proceed to Step S8, where the control section 21 does not to allow the user to use the information processor 1. In other words, the control section 21 may not refer to old authentication recording information which has been recorded for a period of time longer than the predetermined threshold.

In the case where user authentication is performed with reference to past authentication result information, as described above, the control section 21 may also generate authentication result information to be recorded in the storage section 22. The authentication result information generated in this case includes the authentication result, the date and time of the authentication (information of date and time is obtained from the timer section (not shown)), the authentication information that has been used for the authentication, and information indicating that the authentication has been performed by using past authentication result information (referred to as authentication-by-history record).

In the case where the control section 21 also generates authentication result information for authentication performed using past authentication result information, the control section 21 may perform, in the processing of Step S9 of FIG. 2, authentication with selective reference to only authentication result information that includes an authentication-by-server record, among items of authentication result information accumulated in the storage section 22.

In the case where the control section 21 selects the latest authentication result information from among the items of authentication result information found in Step S9 and the selected authentication result information includes an authentication-by-history record, when the time difference between the date and time of the selected authentication result information and the current date and time is greater than (or equal to) the predetermined threshold, the processing may proceed to Step S8, where the control section 21 does not allow the user to use the information processor 1.

In the case where the control section 21 selects the latest authentication result information from among the items of authentication result information found in Step S9, the control section 21 may obtain, depending on whether the selected authentication result information includes an authentication-by-server record or an authentication-by-history record, a value predetermined as a threshold for either the authentication-by-server record or the authentication-by-history record, the thresholds differing from each other. Then, if the selected authentication result information has been stored for a period of time longer than the obtained value, the control section 21 may not refer to the selected authentication result information.

In the above description, authentication result information is recorded in the information processor 1. However, in the exemplary embodiment of the present invention, the method of recording authentication result information is not limited thereto. For example, in the case where authentication information of the user is read from a recording medium such as an IC card, the following processing may be performed. For example, authentication result information may be stored in the recording medium, instead of, or as well as, being recorded in the information processor 1.

In this case, the control section 21 performs the following processing in Step S5 of FIG. 2. Upon receipt of an authentication result from the authentication server 2 in Step S3, the control section 21 generates authentication result information as shown in FIG. 3 and outputs an instruction to record the authentication result information in the recording medium to the card read/writer C of the operation section 23. In the authentication result information, the authentication result, the date and time of the authentication (information of date and time is obtained from a timer section (not shown)), the authentication information that has been used for the authentication, and an authentication-by-server record, are associated with one another. At this time, the control section 21 may also store the authentication result information in the storage section 22.

In this case, recording of authentication result information cannot be performed if the user removes the recording medium from a position where the card reader/writer C can perform reading and writing, in a period from when the authentication information is read to when the control section 21 performs the processing of Step S5. Accordingly, the control section 21 of this exemplary embodiment may be configured so as to determine whether the recording medium has been removed from the position where the card reader/writer C can perform reading and writing, in a period from when the authentication information is read to when authentication result information is written, and the authentication result information is then not written to the recording medium in Step S5 if it is determined that the recording medium has been removed.

In order to determine whether the recording medium has been removed from the position where the card reader/writer C can perform reading and writing, in a period from when the authentication information is read to when authentication result information is written, the control section 21 may perform the following processing. For example, the control section 21 repeatedly (or at least once) instructs the card reader/writer C to read information from the recording medium in a period from when the authentication information is read to when authentication result information is written. Then, based on whether information can be read, or based on information that has been read, the control section 21 determines whether the recording medium, from which the authentication information is read, is placed at the position where the card reader/writer C can perform reading and writing.

In this processing performed in a period from when the authentication information is read to when authentication result information is written, when information can be read, it needs to be determined whether the recording medium loaded at that time, at the position where the card reader/writer C can perform reading and writing, is identical to the recording medium loaded at the position where the card reader/writer C can perform reading and writing at the point in time the authentication information is read, by determining whether identifiers (card IDs) specific to those recording media are identical.

Further, in a case where past authentication result information is held in a recording medium which stores authentication information, the control section 21 may determine in Step S9 whether past authentication result information has been held in the recording medium, instead of searching the storage section 22 for past authentication result information. If past authentication results information has been held in the recording medium, and if the past authentication result information indicates a success in the authentication, the control section 21 may allow the user to use the information processor 1.

As a result of the determination as to whether past authentication result information has been held in the recording medium, if past authentication result information has not been held, or if past authentication result information has been held but does not indicate a success in the authentication, the control section 21 may limit (for example, forbid) the use of the information processor 1 by the user.

Further, if past authentication result information has not been held in the recording medium, or if past authentication result information has been held in the recording medium but does not indicate a success in the authentication, the control section 21 may determine whether past authentication result information has been stored in the storage section 22 by performing the processing of Step S9, and the subsequent step of FIG. 2.

Further, even if past authentication result information has been held in the recording medium, if the time difference between the date and time of the authentication result information and the current date and time exceeds (or equals to) the predetermined threshold, the control section 21 may limit (for example, forbid) the use of the information processor 1 by the user.

In view of the amount of information that can be stored in a recording medium, when authentication is performed with reference to past authentication result information recorded in the recording medium, the control section 21 may not store authentication result information of the authentication, performed with reference to the past authentication result information, in the recording medium.

On the other hand, when authentication is performed with reference to past authentication result information recorded in the recording medium, if authentication recording information of the authentication is stored in the recording medium, the control section 21 should not use this authentication recording information for authentication. In other words, when authentication result information read from the recording medium does not include an authentication-by-server record, the control section 21 may limit (for example, forbid) the use of the information processor 1 by the user.

Further, in this case, when authentication result information read from the recording medium does not include an authentication-by-server record, the control section 21 may determine whether past authentication result information has been stored in the storage section 22 by performing the processing of Step S9 and the subsequent step of FIG. 2.

Further, when authentication result information read from the recording medium includes an authentication-by-history record, if the time difference between the date and time of the read authentication result information and the current date and time is greater than (or equal to) the predetermined threshold, the control section 21 may not allow the user to use the information processor 1 by performing the processing of Step S8 of FIG. 2. The control section 21 may obtain, depending on whether the authentication result information read from the recording medium includes an authentication-by-server record or an authentication-by-history record, a value predetermined as a threshold for either the authentication-by-server record or the authentication-by-history record, the thresholds differing from each other. Then, when the read authentication result information is stored for a period of time longer than the obtained value, the control section 21 may limit (for example, forbid) the use of the information processor 1 by the user without referring to the read authentication result information.

Further, multiple information processors 1 may be provided. When multiple information processors 1 are provided, if each of the multiple information processors 1 cannot communicate with the authentication server 2, authentication may be performed using authentication recording information stored in the recording medium. In other words, authentication may be performed using authentication recording information recorded by another information processor 1.

In the description given above, as the authentication-by-server record, network address information of the authentication server 2 used for the authentication, for example, may be used, which indicates that the authentication has been performed using the authentication server 2. The authentication-by-history record may be information (e.g., a character string of “recording used”) indicating that the authentication has been performed with reference to past authentication recording information. Alternatively, information (e.g., “time out” and response time) indicating the communication state with the authentication server 2 may be used, which is obtained if the control section 21 has performed the authentication. In that case, when communication with the authentication server 2 can be performed because of a good communication state, the control section 21 determines that the authentication recording information includes an authentication-by-server record. Otherwise (e.g., when “time is up”), the control section 21 determines that the authentication recording information includes an authentication-by-history record.

Further, when the control section 21 determines that authentication has succeeded and allows the user to use the information processor 1 in Step S7 of FIG. 2, the control section 21 may store a record (use history) of operations performed by the user at that time as apart of the authentication result information. In this case, the use history may indicate, for example, a function of the information processor 1 used by the user. For example, when the information processor 1 is a multifunction device as described in this exemplary embodiment, the use history may specify a function of “scan”, “copy”, or the like. When the number of sheets allowed to be copied is determined for each month, for example, information indicating the remaining number of sheets allowed to be copied by the user (remaining number of sheets allowed to be copied) may be included in the use history.

In the case where the use history is also recorded, the control section 21 may perform processing as described below. For example, if the control section 21 has allowed the user to use the information processor 1 based on past authentication recording information, the control section 21 may refer to the use history included in this authentication recording information generated from the authentication and allow the user to use only the function specified in the use history.

For example, in a case where a copy operation has been performed after the user has been authenticated in the past, use history indicating that the copy function has been used is held in the storage section 22. In this case, to allow the user to use the information processor 1 with reference to past authentication recording information, the control section 21 refers to the use history and allows only the use of the copy function. In other words, for the other functions such as a scan operation, the control section 21 may not perform processing corresponding thereto. The control section 21 may end processing after displaying a message of “authentication cannot be performed”.

When the use history included in authentication recording information generated from authentication includes information indicating the remaining number of sheets allowed to be copied, the control section 21 may subtract the number of sheets to be copied, which is instructed by the user, from the remaining number of sheets allowed to be copied. When the obtained value is equal to or smaller than “0”, the control section 21 may end processing after displaying a message of “the requested number of sheets to be copied exceeds the remaining number sheets allowed to be copied”.

When the use history includes information for identifying in advance a use location, such as information for identifying a used information processor 1, and authentication is performed with reference to authentication recording information, the control section 21 may determine whether to allow the use of the information processor 1 based on whether there is use history of the information processor 1 to be used by the user.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system, comprising:
an authentication information receiving section that receives authentication information used for authentication from a user;
an authentication information transmitting section that transmits the received authentication information to a first device;
an authentication result receiving section that receives a result of the authentication performed by the first device;
a first availability determining section that determines whether a second device is available to the user based on the result of the authentication received by the authentication result receiving section; and
a second availability determining section that, when the authentication cannot be performed by the first device, obtains a past authentication result, and determines whether the second device is available based on the obtained past authentication result.

2. The information processing system according to claim 1, further comprising an authentication result holding section that holds the result of the authentication received from the first device,
wherein the second availability determining section obtains the past authentication result from the authentication result holding section, and determines whether the second device is available based on the obtained past authentication result.

3. The information processing system according to claim 1, wherein:
the authentication information receiving section receives the authentication information from a recording medium that stores the authentication information;
and the information processing system further comprising
a recording section that records the result of the authentication received from the first device in the recording medium, from which the authentication information is received; and
the second availability determining section obtains the past authentication result from the recording medium, and determines whether the second device is available based on the obtained past authentication result.

4. The information processing system according to claim 1, further comprising a use history holding section that holds the user's usage history of the second device,
wherein the second availability determining section determines whether the second device is available based on the obtained past authentication result and the usage history.

5. The information processing system according to claim 1, wherein the second availability determining section determines whether the second device is available based on the past authentication result which has been recorded within a predetermined period of time.

6. An information processing method, comprising:
receiving authentication information used for authentication from a user;
transmitting the received authentication information to a first device;
receiving a result of the authentication performed by the first device;
determining whether a second device is available to the user based on the result of the authentication received; and
obtaining a past authentication result when the authentication cannot be performed by the first device, and determining whether the second device is available based on the obtained past authentication result.

7. The information processing method according to claim 6, further comprising holding the result of the authentication received from the first device, and wherein
in obtaining the past authentication result, obtaining the past authentication result from the authentication result held.

8. The information processing method according to claim 6, wherein:
in receiving the authentication information, receiving the authentication information from a recording medium that stores the authentication information;
and the method further comprising
recording the result of the authentication received from the first device in the recording medium, from which the authentication information is received; and
in obtaining the past authentication result, obtaining the past authentication result from the recording medium.

9. The information processing method according to claim 6, further comprising holding the user's usage history of the second device, and
determining whether the second device is available is performed based on the obtained past authentication result and the usage history.

10. The information processing method according to claim 6, wherein
determining whether the second device is available is performed based on the past authentication result which has been recorded within a predetermined period of time.

11. A computer readable recording medium storing a program enabling a computer to perform a process comprising:
receiving authentication information used for authentication from a user;
transmitting the received authentication information and receiving a result of the authentication performed by a first device;
determining whether a second device is available to the user based on the result of the authentication received from the first device; and
obtaining, when the authentication cannot be performed by the first device, a past authentication result, and determining whether the second device is available based on the obtained past authentication result.

12. The computer readable recording medium according to claim 11, the process further comprising holding the result of the authentication received from the first device, and wherein
in the process of obtaining the past authentication result, obtaining the past authentication result from the authentication result held.

13. The computer readable recording medium according to claim 11,
in the process of receiving the authentication information, receiving the authentication information from a recording medium that stores the authentication information;
and the process further comprising
recording the result of the authentication received from the first device in the recording medium, from which the authentication information is received; and
in the process of obtaining the past authentication result, obtaining the past authentication result from the recording medium.

14. The computer readable recording medium according to claim 11, the process further comprising holding the user's usage history of the second device, and
determining whether the second device is available is performed based on the obtained past authentication result and the usage history.

15. The computer readable recording medium according to claim 11, wherein
determining whether the second device is available is performed based on the past authentication result which has been recorded within a predetermined period of time.

16. A computer data signal embodied in a carrier wave for enabling a computer to perform a process for authentication, the process comprising:
receiving authentication information used for authentication from a user;
transmitting the received authentication information and receiving a result of the authentication performed by a first device;
determining whether a second device is available to the user based on the result of the authentication received by the first device; and
obtaining, when the authentication cannot be performed by the first device, a past authentication result, and determining whether the second device is available based on the obtained past authentication result.

17. The computer data signal according to claim 16, the process further comprising holding the result of the authentication received from the first device, and wherein
in the process of obtaining the past authentication result, obtaining the past authentication result from the authentication result held.

18. The computer data signal according to claim 16,
in the process of receiving the authentication information, receiving the authentication information from a recording medium that stores the authentication information;
and the process further comprising
recording the result of the authentication received from the first device in the recording medium, from which the authentication information is received; and
in the process of obtaining the past authentication result, obtaining the past authentication result from the recording medium.

19. The computer data signal according to claim 16, the process further comprising holding the user's usage history of the second device, and
determining whether the second device is available is performed based on the obtained past authentication result and the usage history.

20. The computer data signal according to claim 16, wherein
determining whether the second device is available is performed based on the past authentication result which has been recorded within a predetermined period of time.
